(19) United States
(12) Patent Application Publication
(10) Pub. No.: US 2016/0223264 A9
(43) Pub. Date: Aug. 4, 2016

(54) COMPACT ALUMINIUM HEAT EXCHANGER WITH WELDED TUBES FOR POWER ELECTRONICS AND BATTERY COOLING

(71) Applicant: Gränges AB, Stockholm (SE)

(72) Inventors: Sampath Desikan, London (GB); Xu House, Shanghai (CN); Steven Meijers, Finspang (SE)

(73) Assignee: Gränges AB, Stockholm (SE)

(21) Appl. No.: 14/415,166

(22) PCT Filed: Jul. 19, 2013
(86) PCT No.: PCT/SE2013/050920

§ 371 Date: Jan. 16, 2015

(30) Foreign Application Priority Data
Jul. 19, 2012 (CN) 201210321455.4

(51) Int. Cl. F28D 1/03; B23P 15/26; F28F 3/02

(52) U.S. Cl. CPC F28D 1/0366; F28F 3/025; B23P 15/26; B23P 2700/10

(57) ABSTRACT

Compact aluminum heat exchanger manufactured from welded flat tubes with internal and/or external fins for cooling of power electronic devices and/or battery cells. The fin insert is prefabricated and inserted into the flat tubes for facilitating of flow turbulence and thus heat dissipation and have fins with undulating or wavelike shape manufactured by sampling or corrugating. Flat tubes are bent and welded along their length on their smaller side facilitating mechanical strength of the tubes. Tubes are manufactured from a core alloy containing 0.3 to 1.8 wt % Mn, 0.25-1.2 wt % Cu, ≧0.02 wt % Mg, ≧0.01 wt % Si, ≧0.05 wt % Fe, ≦0.2 wt % Cr, balance aluminum and unavoidable impurities up to 0.05 wt %. Fin inserts are manufactured from aluminum alloy comprising Mn 0-3 wt %, Fe 0-1.5 wt %, Cu 0-1.5 wt %, Mg 0-1.5 wt %, Si 0-1.0 wt %, Zn 0-4 wt %, Ni 0-1 wt % and Zr, Ti, Cr V 0-0.3 wt % each.

### TECHNICAL FIELD

The invention relates to a heat exchanger or a cooler suitable for thermal management of electronic components or battery cells that generate heat. The invention is particularly suitable as a heat exchanger for electric power train in a hybrid electric vehicle (HEV) or electrical vehicle (EV) but also applicable in other technical areas for cooling various electric components.

### BACKGROUND AND DESCRIPTION OF THE PRIOR ART

In order to ensure reliability of power electronic devices in hybrid electric vehicles, heat generated from power electronics assembly need to be dissipated. The substrate of power electronic devices typically has three layers; an etched metal track which forms electrical connections of a circuit, an intermediate layer, i e a plate of electrical insulating material of ceramic type, and a metal plate so called a heat spreader which is connected to the assembly to facilitate spreading heat and provide mechanical support. An alternative is an extruded heat sink with external fins for air cooling serving as a heat sink having attached to it the heat spreader in order to dissipate the heat more effectively. In automotive power electronics, heat sinks can be liquid cooled and designed using either multi-port aluminum extrusions or cold plates containing machined micro-channels. Heat sinks which are a part of the heat exchangers can also be made out of aluminum blocks with an embedded copper tube. When making components coolers for HEV/EV which requires dissipation of large amount of heat, only extruded or folded tubes have been used so far.

The cost involved in machining accurate micro-channels from flat aluminum work-piece plate material increases substantially with size and complexity of the required flow paths.

Heat exchangers or component cooler for automotive vehicles normally have cooling tubes that are either extruded or made by folding braze clad strip into e.g. a B-shape and then brazing these into leak proof tubes when assembling the heat exchanger. They may also be manufactured by brazing an array of stamped metal plates which when brazed provides an integrated set of cooling tubes/channels, header and return pipes, the so-called drawn cup plate design.

U.S. Pat. No. 7,571,759 discloses a heat exchanger using the tubes formed from press molded aluminum plates in a stacked type cooler in which a plurality of cooling tubes are arranged and stacked in such a fashion as to alternately interpose the electronic components with the cooling tubes. The press molded plates are brazed with an intermediate plate providing a risk for leakage at high internal pressures. The electronic components are usually mounted in contact with the cooling tubes via a ceramic plate and heat-conductive grease, a costly process and an inflexible design which suffers from being prone to corrosion.

Extruded tubes forming a heat sink typically require a Zn coating to provide adequate corrosion resistance to the extruded tubes. During the braze process, Zn diffuses into the extruded tube material and the resulting Zn concentration gradient provides corrosion protection. However, this method of corrosion protection of tubes also causes undesirable Zn segregation in fillets. Thus although this approach can protect the tube of also inevitably accelerate fillet corrosion. In contrast, since other mechanisms such as brown band, Cu concentration profile, Ti bands etc are used to develop corrosion resistance in rolled aluminum brazing sheet materials, they do not suffer from the aforementioned fillet corrosion associated with heat exchangers produced using extruded multiport tubes.

For the liquid cooled heat exchangers of a flat design, comprising two manifolds for input and output of cooling liquid and interconnected by a plurality of cooling tubes as shown in FIG. 3 of U.S. Pat. No. 7,571,759 could be used. These extruded cooling tubes forming the heat sink have relatively thick inner fins due to the extruding process requirements and therefore rather heavy (require more material).

Extruded tubes cannot be made with very thin walls which mean that the weight and cost for the heat exchanger increases. The cooling tubes are preferably made flat as such design allows to mount the components to be cooled directly on the tube surface without a intermediate heat spreader or even cool the element between two tubes from its both sides when necessary, which makes the design of the heat exchanger more compact as illustrated in FIG. 1 of U.S. Pat. No. 7,571,759.

There are also limitations regarding the freedom of design in order to be able to produce multiport extruded tubes, since there are requirements as of minimum web thickness to the height.

Patent application US2008/0185130 discloses extruded cooling tubes for a heat exchanger for a vehicle. The tubes are provided with a plurality of internal ribs or fins extruded together with the tubes as one piece and improving the heat dissipation. This design does not allow minimizing the material consumption and making a heat exchanger with a thinner intermediate walls and reduced weight.

The more preferable, thinner and lighter flat tubes can be manufactured as illustrated in FIG. 6 of U.S. Pat. No. 7,571,759 by separately manufactured outer and intermediate plates which are then bonded one to another including fins therebetween.

Due to material formability requirements, the drawn cup design cooling tubes according to the prior art U.S. Pat. No. 7,571,759, FIG. 6, require fully soft braze clad materials which in turn are prone to core erosion.

Such drawn cup tube design suffers also from a reduced stiffness of the final tube as softer metal and/or alloy is used for bending while the final tube shall remain a good flatness in order to provide the best contact for the attached component. The drawn cup tube subjected to the fluid pressure may leak along the bended edges. Therefore there is a need for a tube free from these disadvantages which provides a high heat transfer effect. The fin insert used for drawn cup design tube does not provide the optimal coolant flow.

For the more compact mounting of cooled elements and cooling on the both sides, the flatness of the cooling tubes in longitudinal and transverse directions or non-bending and twisting over the entire length of the cooling tube is an essential feature. This is difficult to achieve by known drawn cup type tubes with a thin outside plates that shall withstand high internal liquid pressure which will deform the outside tube shell. Therefore the best flatness required for the efficient heat transfer cannot be achieved by this known type of drawn cup flat tubes.

### SUMMARY OF THE INVENTION

The object of the present invention is to provide a heat exchanger with minimized weight and increased heat transfer capacity which may efficiently regulate the temperature of electronic components integrated in the heat exchanger. The other objective is the use of another type of flat cooling tubes as a heat sink such as welded tubes with optimized internal fins design according to the invention, the tubes providing a higher stiffness over the cooling tubes length which results in increased heat transfer efficiency and a more compact and light weight heat exchanger design as well as long life corrosion properties due to the use the other material.

The heat exchanger for thermal management of heat generating or heat radiating components comprising; two manifolds for directing coolant fluid in and out of the heat exchanger, a plurality of flat cooling tubes having two ends to be mounted to the manifolds, two sides in a longitude direction and two component carrying surfaces between said two sides; flat tubes are aligned substantially in parallel to each other between the manifolds so that their carrying surfaces are substantially parallel and facing each other, the tubes being attached at each end to the adjacent manifold to allow coolant to flow through the tubes, the flat cooling tubes are formed of a sheet material by welding to form a weld joint. The welding can be high frequency or any other suitable welding method.

For the semiconductor module to be mounted with the best heat transfer/dissipation, the surface of the tube should be as flat as possible. Use of fin inserted welded tubes provide for a more rigid structure than folded tubes, and may at the same time be made more cost effectively and with a lower weight than extruded tubes.

Besides the semiconductor module described above, a power transistor, a power FET, an IGBT, and so forth, can be used as the electronic component.

The coolant described above can be water a natural coolant such as water or a non-water based coolant such as HFC134a.

Core erosion (liquid film migration, LFM) deteriorates the corrosion resistance of the brazed heat exchangers. These problems with a need to decrease the heat exchanger weight, obtain a compact design and increase efficiency of the heat transfer may be overcome by the use of welded tube design which may be produced in other tempers, e g H14, H24 and do not have the severe localized deformation as the drawn cup tubes.

According to another aspect of the invention, the surface roughness of the heat spreader may be altered by a cold rolling process to a value in the range Ra=0.02-1.14 micrometer with a view to improve heat transfer.

The high frequency welded aluminum tubes provide coolant flow paths for the purpose of thermal management of automotive power electronics and batteries. In combination with fin inserts, the flat tubes of this invention provide substantial increase in heat transfer area resulting in superior heat transfer characteristics in comparison to other designs with tubes based on extrusions or folded or stamped plates. The flat tubes for the heat exchanger according to the invention are manufactured from a sheet of metal, which is bent and then joined into the tubular shape sleeve by high frequency or other type suitable welding. After that, the tube can be pressed further to the desired flat tube shape. The material of the flat tubes is preferably aluminum and its alloys, wherein the core alloy of the high frequency welded tube contains 0.3 to 1.8 wt % Mn, 0.25-1.2 wt % Cu, ≧0.02-wt % Mg, ≧0.01 wt % Si, ≧0.05 wt % Fe, ≦1.25 wt % Cr, balance aluminum and unavoidable impurities up to 0.05 wt %.

The core alloy temper is H14/O/H24, and preferably H14/H24. These material tempers in combination with the aforementioned chemistry window provide the best combination of strength, corrosion resistance and required degree of formability to achieve flatness of the welded tubes.

A flat cooling tube for use in a compact heat exchanger is bended from a sheet material to form a sleeve, welded along the adjacent edges to form a tubular component and pressed to form the flat cooling tube having a weld joint at the smaller dimension side.

The welding or the welded seam usually is situated on the side of the flat tube and thus increases the stiffness of the flat tube and resistance to bending moment. This provides an improved contact between the component and the tube and thus facilitates the heat transfer. The heat exchanger constituent parts are assembled by brazing. The brazing can be a fluxless brazing method or any other conventional brazing methods

A fin insert is formed by one of embossing, rolling, corrugating and stamping from a sheet material and then cut into pieces of the appropriate dimension. Furthermore, the fin insert is designed having wave-like fins along the channel for improving thermal performance by increasing turbulence of coolant flow and internal surface area. Stiffness of the tube is also improved while the inner fins are acting as ribs. The fins can have undulated or wave-like shape along their sides or any other uneven surface contacting the coolant fluid.

A method of manufacturing a heat exchanger comprises steps of: bending a sheet material to form a sleeve, welding the sleeve to form a tubular component, pressing the tubular component to obtain a flat tube; manufacturing two manifolds with openings on their sides for receipt of ends of the tubes, inserting flat cooling tubes into the openings so as to form the heat exchanger, characterized by assembling of the constituent parts by brazing, including a flux free brazing.

Use of the heat exchanger having welded aluminum tubes with fin-insert allows scalability since different high frequency welded aluminum tubes can be dimensioned depending on the heat load or foot print of power electronics devices. The use of heat exchanger according to the invention for thermal management of any heat radiating component is suitable in one of hybrid and electrical vehicle.

Thermal performance of the heat exchanger may be further improved by the use of additional external fins, separating the tubes (see FIG. 2, 3). These fins are brazed onto at least some of the tube carrying flat surfaces.

The heat exchanger according to the invention provides reduction of its weight and a possibility to make a long-life corrosion design.

### BRIEF DESCRIPTION OF THE DRAWINGS

FIG. 1 shows a heat exchanger or cooling module according to the prior art.

FIG. 2 shows a heat exchanger according to the invention equipped also with additional external fins for cooling a battery cells and side plates for improving the stiffness of the exchanger.

FIG. 3 shows the partly cross sectioned heat exchanger to illustrate the mounting of the flat tubes into the manifolds.

FIG. 4 (A-E) shows five different fin inserts manufactured by different methods and providing the different insert shapes.

FIG. 5 shows the flat heat exchanger tube after calibrating with a partly removed tube material and assembled with the fin insert. The cross sections A, B illustrate the variety of achievable configurations.

FIG. 6 shows a prior art brazed flat tube with inserted fins with the cooling components situated onto the tube carrying surface.

FIG. 7 shows the experimental set up of equipment when testing the thermal performance of the tube according to the invention.

### DETAILED DESCRIPTION OF THE INVENTION

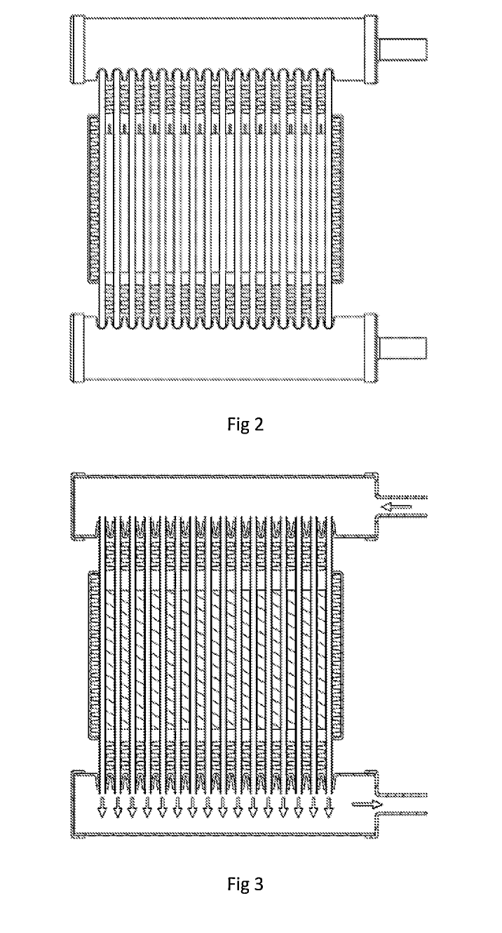

A so called heat sink module or a heat exchanger 20 as illustrated in FIG. 2, 3 is manufactured by assembling a number of flat tubes 3 manufactured from a metal sheet 11 by bending the sheet to a tubular form to form a sleeve, interconnecting the adjacent sheet edges by high frequency welding or any other suitable welding method forming a weld joint 12, the formed sleeve is pressed to form a flat cooling tube 3. Such flat welded cooling tubes 3 are particularly suitable and made for use into the heat exchanger 20 according to the invention. The heat exchanger 20 according to the invention is particularly suitable for thermal management of any heat radiating component s 5, 6 used in one of hybrid and electrical vehicle.

The weld joint (12) is preferably situated at the smaller dimension side 14, 14′ of the flat cooling tube 3 to minimize the leakage risks. The tubular component is pressed to approximate the flat tube shape of a bit larger size than a pre-formed fin insert 8. The pre-fabricated fin insert 8 is inserted automatically or manually into the flat cooling tube 3 in its longitudinal direction in order to facilitate the heat dissipation. Then the tube 3 is calibrated by rolling to the final dimension equal to the height of the inserted fins 8 so that the fins are fast fixed into the tube 3. These pre-formed flat tubes are attached by their ends 3a, 3b through holes in the connecting manifolds 1, 2 sides to the manifolds 1, 2 and brazed to form an entity as the heat exchanger 20. The flat tube 3 having the pre-fabricated fin inset 8 facilitates the heat transfer or heat dissipation efficiency.

The fin insert 8 is either stamped or manufactured by rolling of a thin fins sheet material between two rolls having the desired pattern on their surfaces so as to emboss this pattern to fin sheet in a known manner.

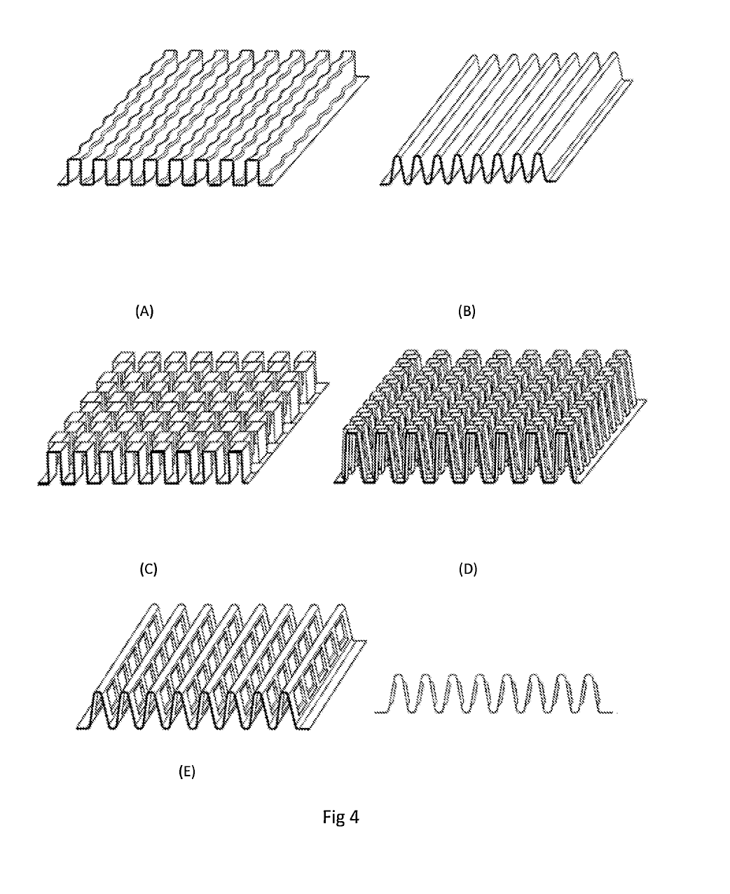

The embossed or corrugated fin sheet of various shapes as illustrated in FIG. 4 (A-E) for facilitating the coolant flow turbulence and thus thermal efficiency of the tubes then cut into appropriate size pieces forming the fin insert 8.

The insert 8 is formed by one of embossing, rolling, corrugating and stamping from a sheet material and then cut into the pieces of the appropriate dimension. The pre-fabricated fin insert 8 has preferably fins with uneven shape along their length, an undulating or wave-like shape along their length. The other shapes with uneven side fins surfaces also can be used. The fins in the fin insert 8 can have off-set geometry off-set along the length of the tube, to be dislocated relative each other along the fins or flow channel length. The fin insert 8 could have braze filler alloy cladding on at least one side or on the both, on the top 10 of fins and the bottom 9 of fin insert 8. The braze filler alloy has Mg content of 0.05-0.7 wt % Mg. The thickness of material of the inserted fin insert 8 may vary between is 0.04-0.8 mm, and is preferably 0.5 to 0.7 mm.

The fin insert 8 is manufactured by one of direct chill casting, continuous casting, twin roll casting or belt casting from the from an aluminum alloy comprising Mn 0-3 wt %, Fe 0-1.5 wt %, Cu 0-1.5 wt %, Mg 0-1.5 wt % Si 0-1.0 wt %, Zn 0-4 wt %, Ni 0-1 wt % and Zr, Ti, Cr V 0-0.3 wt % each. Then fin insert 8 is subjected to one of corrugating, stamping and embossing of the material so as to form a plurality of fins and cutting the material having the plurality of the fins in the pieces of the appropriate size.

The outside dimensions of the insert 8 corresponds to the flat cooler tube 3 inner dimensions. The various shapes of fin inserts forming the channels for a coolant liquid within the tubes allow varying the cooler flow turbulence and the thermal efficiency of the heat exchanger depending on the requirements of the cooling components. This design provides a very flexible manufacturing possibility. At least one flat cooling tube 3 has an inserted a pre-fabricated as described above internal fin insert (8), but preferably all of them for improving the heat dissipation. The height of the cooling tube 3 can vary depending on the heat exchanger dimensions and required heat dissipation, but here the tube 3 is done in a range of about 1.2-15 mm. The frequency welded cooling flat tubes 3 can have a braze cladding on at least one side called the carrying surface 13 or the both sides, inside and/or outside of the tube 3.

The components 5, 6 can be attached directly to the tubes carrying surfaces 13 as illustrated in FIG. 2, 3 eliminating the heat spreader or other intermediate elements which reduces weight and increases heat dissipation, wherein the component 5 is a battery cell and a component 6 is a power electronic component to be cooled. The heat radiating components 5, 6 to be cooled by the heat exchanger 20 can be attached onto at least one of the flat tube 3 carrying surface 13 by glue, thermal grease, mechanically and/or brazing. At least some of the cooling flat tubes 3 can be separated by a row of brazed external fins 4 for improving mechanical properties of the heat exchanger and simultaneous increasing efficiency of the heat dissipating.

The heat exchanger 20 has at least one of the additional external fins 4, 7 and at least one stiffening plate 15 for improving the stiffness of the heat exchanger 20 and simultaneously increasing heat dissipation.

Alternatively, the components can be fixed mechanically in a known manner or just pressed between two neighboring flat tubes 3. When desired, the components might be brazed to the tubes including method of a fluxfree brazing.

Most often the components are power electronic components used in hybrid electric or electrical vehicles. The component 5, 6 can be a battery cell or any electronic circuit or the like. If required, the component 5, 6 can be mounted onto an intermediate plate which then is mounted onto the flat tube 3 surface 13. The component carrying surface 13 of at least one of the flat cooling tubes 3 is preferably has a roughness of Ra 0.02 to 1.14 micrometer in order to provide better contact between the components 5, 6 and the cooling tube 3 surface 13.

In order to facilitate the heat dissipation and increase a turbulence of the coolant flow, internal fin inserts 8 can be inserted in the flat tubes 3. Furthermore, external additional fins 4 can be provided between the tubes 3 as shown in FIG. 2. Additional side panels 15 made of a sheet material according to known methods can be added to strength a package of the flat tubes 3, and the external additional fins 7 can be added between the outmost flat tube 3 and the panel 15 to facilitate the heat dissipation. The fins 7 and panels 15 can be brazed when desired.

The method of manufacturing fins or fin insert 8 allows achieving very thin fins which save material and weight of the cooler or heat exchanger 20. Fins can be produced by Direct Chill (DC) casting, Continuous Casting (CC), Twin Roll Casting (TRC) or belt casting preferably an aluminum alloy comprising Mn 0-3 wt %, Fe 0-1.5 wt %, Cu 0-1.5 wt %, Mg 0-1.5 wt % Si 0-1.0 wt %, Zn 0-4 wt %, Ni 0-1 wt % and Zr, Ti, Cr V 0-0.3 wt % each is used.

The method of manufacturing flat tubes 3 according to the invention does not require the brazing of the inner or internal fins to the tubes inner surface but allows this if necessary. The outer surface 13 of the tubes might be provided with an aluminum clad by roll cladding. This allows additional assembling of the outside fins 4 between every second tube 3 into the heat exchanger 20 structure and then brazing the heat exchanger 20 in a CAB furnace to form a continuous cooling fluid circuit, facilitating the cooling or heat transfer effect.

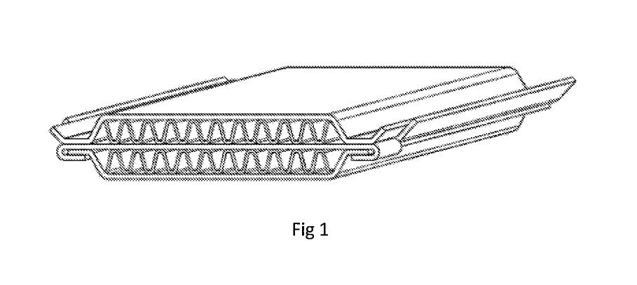

Power electronics packages or components 5, 6 might be attached onto a ceramic carrier with metalized surfaces to form electronic component substrates and the substrates may be inserted between the tubes of the heat exchanger and attached to the tube surfaces by sok dering or greasing Alternatively and preferably the electronic packages 5, 6 can be fixed directly to the flat tubes 3 of the invention due to their improved flatness by thermal grease or other known conventional means. As the flat tubes 3 according or the invention are not bend at their edges (as in the prior art drawn cup embodiment of FIG. 1), the material used for the tubes is stiffer and welded seam 12 provides additional stiffness and resistance to the bending, which allows mounting of the components 5, 6 directly onto the tube surface which reduces material need and manufacturing costs.

Insert 8 can be inserted into the high frequency welded tubes 3 either manually or through an automated process. The set of fins 8 can be manufactured by rolling, running a fin sheet material between two rolls with patterned surfaces which during the interacting embossing or corrugating the material. Material is then is cut in fin inserts 8 of the appropriate size.

The preferred fin insert geometry can be described as follows:

4*arc-tan(30°)*A<Wave length(L)<4*arc-tan(10°)*A(^{˜}Preferably:4*arc-tan(15°)*A),

0.2<Tube thickness<0.45 mm(^{˜}Preferably:0.4 mm)

2<Tube height<4.8 mm(^{˜}Preferably:3.8 mm)

1.8<Fin height(Fh)<4.4 mm(^{˜}Preferably:3 mm)

1.2<Fin Pitch(Fp)<2 mm(^{˜}Preferably:1.6 mm)

0.08<Fin Thickness<0.1*Fp(^{˜}Preferably:0.18 mm)

0.2*Fp<Wave amplitude(A)<0.4*Fp(^{˜}Preferably:0.36Fp)

2*tan(10°)*A<Wave length(L)<2*tan(30°)*A(^{˜}Preferably:2*tan(15°)*A)

Generally speaking, a manual insertion is mostly used for a low volume production. In case of an automated fin insert 8 insertion, the welded flat tubes 3 which are slightly bigger in their inner size than the fin insert 8 are cut to the required length using a saw or online cut condition. After welding process, slightly larger size tube 3 facilitates fin insert 8 insertion. Fin insert 8 from the fin rolls are cut to the required length. An automatic wet flux operation and drying of the fin inserts 8 before insertion can be added to the production if required. Fin inserts 8 are inserted into the tubes using an automated process and after the fin-insertion, the tube is finally calibrated to ensure good contact between tube inner wall and the fin insert outer surface 9, 10. Inserted fins 8 can be of different shape, thickness and geometry ex: offset or corrugated and louvered type.

The inserted fins 8 preferably have an undulating shape (as illustrated in FIG. 4A) while the other shapes (FIG. 4 b-e) are also possible, so that the path of the cooling fluid becomes swirly and a better cooling performance is obtained. Different alloys may be used for the internal fins and the tubes, which also provide more freedom as regards e g long life corrosion design.

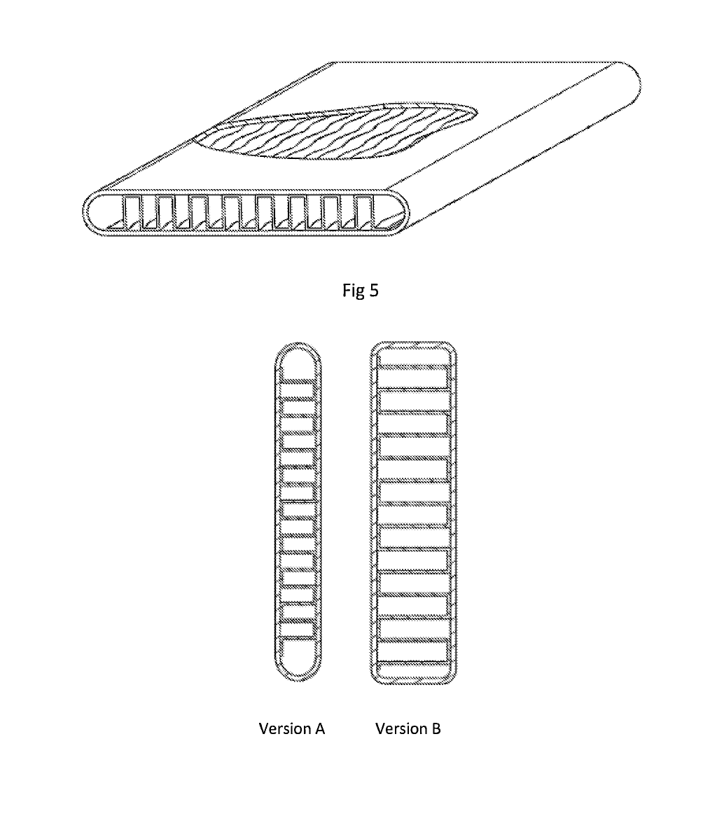

FIG. 5 illustrates the cross section of the tube according to the invention in version “A” and version “B”, which are just the different product specifications in different size. Version “B” is applied to larger tube with height>10 mm, while version “A” has semicircular edges which is suitable for smaller tube and can sustain higher internal pressure. There will be a waste of material if version “A” is applied in large tubes, length of side edges are elongated and vice versa. It is very difficult to fold the tube sheet when making the small tube as version “B”.

Tube material 11 below 0.1 mm is insufficient to take the load positioned as a part of a power electronic component. When the gauge is above 1.5 mm it becomes increasingly difficult to maintain flatness on the surfaces of tubes 3.

A minimum thickness of material of about 0.04 mm is required to achieve minimum strength of the tubes 3. Beyond 0.8 mm, the cracking tendency of fins increases.

For optimization of flat tubes design, computer modeling and computer calculation were used. The heat input, Q, from the heating unit was calculated from coolant cycle, i.e. by

$$Δ T = \frac{{T}_{3} + {T}_{4}}{2} - \frac{{T}_{1} + {T}_{2}}{2}$$

$$Q = {C}_{p} \dot{m} ( {T}_{1} - {T}_{2} ) / 60$$

$${R}_{t} = Δ T / Q$$

$$Nomenclature \text{:}$$

$${C}_{p} \text{:} Specific heat of coolant , kJ \text{/} kg \text{-} K$$

$$\dot{m} \text{:} Volumetric flow rate of coolant , l \text{/} m$$

$${P}_{1} \text{:} Static pressure at inlet of cooling tube , bar$$

$${P}_{2} \text{:} Static pressure at outlet of cooling tube , bar$$

$$Q \text{:} Heat transfer rate from cooling , w$$

$${R}_{t} \text{:} Thermal resistance , K \text{/} W$$

$${T}_{1} \text{:} Temperature at inlet of cooling tube , K$$

$${T}_{2} \text{:} Temperature at outlet of cooling tube , K$$

$${T}_{3} , {T}_{4} \text{:} Termperature on tube surface ( interface between heat source and heat sink ) , K$$

Three different flow rates (1 L/min, 1.5 L/min, 2 L/min) of the coolant fluid (50% glycol mixed water) was used and the temperature & pressure drop was recorded.

The initial coolant temperature was set to 20 deg C. and the electrical power emitted was 500 W.

TABLE 1

| | | Thermal | Weight of | Weight |
|---|---|---|---|---|
| Product | Pressure drop | resistance | tube/plate | of fins |
| Prior art heat | 868 | 0.13 | 16 | 10 |
| exchanger/cooler | | | | |
| Invention heat | 555 | 0.09 | 9.4 | 5.1 |
| exchanger/cooler | | | | |

The calculation result shows that the heat exchanger according to the invention gives a lower pressure drop and a better thermal conductance at the same time as the weight is lower.

### Thermal Test

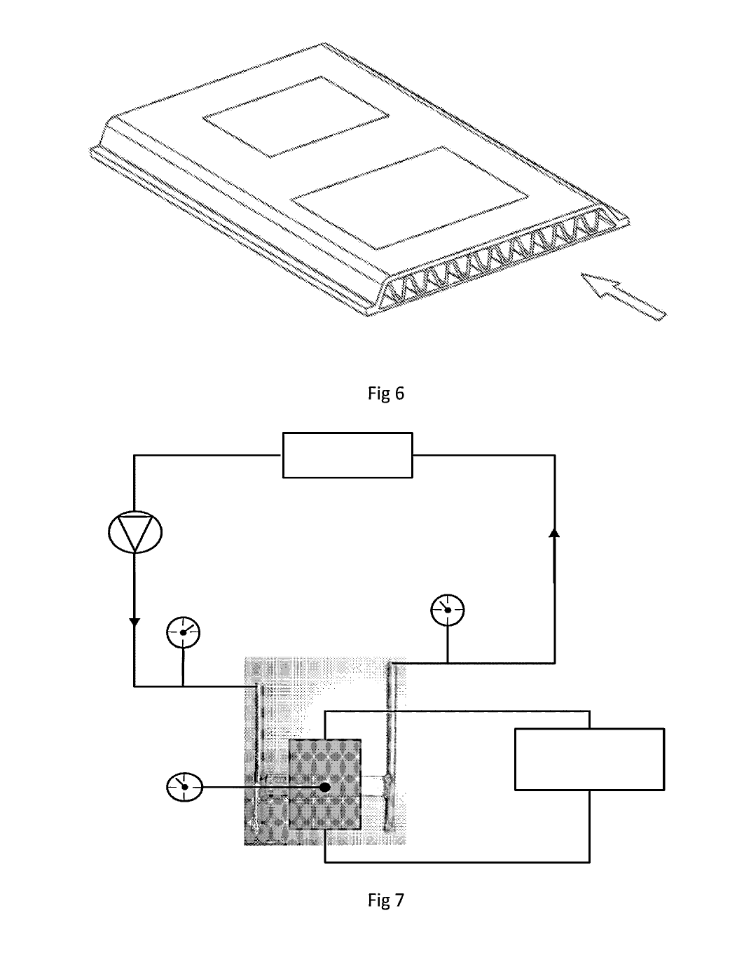

A flat tube with a fin insert as illustrated in FIG. 6 (known as prior art) was tested on the equipment as in FIG. 7 and compared with the model calculation as in Table 1.

The thermal tests were conducted illustrating the increased heat efficiency of the heat exchanger of the invention compared to the prior art heat exchanges of the drawn cup type (bended or brazed together as shown in FIG. 1—prior art). The tests were performed on a module having the flat welded tube 19 according to the invention on the equipment as illustrated in FIG. 7. The coolant fluid is circulated in the circle by a pump 16 and its temperature is controlled by thermostat 15. The temperature and pressure of the fluid are controlled before and after passing the tested flat tube 19 by sensors 17, a heat radiating component 6 is connected to a battery 18. The equipment consists of an electrical heating aluminum block with electricity wires inside and a thermal couple for temperature probing on the bottom brazed onto a flat tube surface (see FIG. 6). The surfaces of tube were painted with thermal grease before installing the heating source to improve the contact between the tube and the surface of the heating source.

To reduce the heat radiation to surrounding air, a thermal insulation plate is present on the top of the aluminum block.

The test was repeated on a heat exchanger where the welded tubes according to the invention (FIG. 5) were exchanged to the folded or drawn cup plate tubes according to the embodiment of FIG. 1 (Prior art) and confirmed the previous calculations results.

The result as in Table 1 shows that the heat exchanger according to the invention gives a lower pressure drop and a better thermal conductance at the same time as the weight is lower.

Many other modifications can come to the mind of a skilled person within the scope of the invention. It is to be understood that all terms of the description are to be interpreted in general terms and the drawings are only for illustrating purpose and not limiting the scope of the invention.

1. A heat exchanger (20) for thermal management of heat radiating components (5,6) comprising:
two manifolds (1,2) for directing fluid in and out of the heat exchanger (20);
a plurality of flat tubes (3) having two ends (3a, 3b) to be mounted to the manifolds (1,2), two sides (14,14′) in a longitude direction and two component carrying surfaces (13. 13′) between two sides (14, 14′); tubes (3) are aligned substantially in parallel to each other between the manifolds (1, 2) so that their carrying surfaces (13, 13′) are substantially parallel facing each other, the tubes (3) being attached at each end (3A, 3B) to the adjacent manifold (1, 2) to allow coolant to flow through the tubes (3), characterized in that the flat tubes (3) are formed of a sheet material (11) by welding to form a weld joint (12).

2. The heat exchanger (20) of claim 1, wherein the weld joint (12) is situated at the side (14, 14′) of the flat tube (3).

3. The heat exchanger (20) of claim 1, wherein the tube carrying surfaces (13, 13′) are adapted for direct attachment of the component (5, 6) thereon.

4. The heat exchanger (20) of claim 3, wherein the heat radiating component (5, 6) to be cooled is attached onto at least one tube carrying surface (13, 13′) by one of glue, thermal grease, mechanically and brazing.

5. The heat exchanger according to any of claims 1-4, wherein the component carrying surface of at least one of the tubes is controlled to achieve a roughness of Ra 0.02 to 1.14 micrometer.

6. The heat exchanger (20) according to claim 1-5, where at least one of the components (5, 6) is power electronic component.

7. The heat exchanger (20) according to claim 1-6, where at least one of the components (5) is a battery cell.

8. The heat exchanger (20) according to any of the previous claims, wherein at least one tube (3) has inserted a pre-fabricated internal fin insert (8).

9. The heat exchanger (20) of claim 8, wherein the at least pre-fabricated internal fin insert (8) is inserted manually or automatically into the flat tube (3) in its longitudinal direction in order to facilitate the heat dissipation.

10. The heat exchanger (20) of claim 8, wherein the fin insert (8) is manufactured by one of stamping, corrugating and embossing.

11. The heat exchanger (20) according to claim 8, where the inserted pre-fabricated fin insert (8) has fins with an undulating shape along their length.

12. The heat exchanger (20) according to claim 8 where the inserted fins have off-set geometry off-set along the length of the tube.

13. The heat exchanger (20) according to any of the previous claims, wherein at least some of the cooling tubes (3) are separated by a row of brazed external fins (4).

14. The heat exchanger (20) according to any of the previous claims, wherein the core alloy of the high frequency welded tube (3) sheet (11) contains 0.3 to 1.8 wt % Mn, 0.25-1.2 wt % Cu, ≧0.02-wt, ≧0.02 wt % Mg, ≧0.01 wt % Si, ≧0.05 wt % Fe, ≦0.25 wt % Cr, balance aluminum and unavoidable impurities up to 0.05 wt %.

15. The heat exchanger (20) according to any of the previous claims, wherein the core alloy of the tube material sheet (11) temper is H14/O/H24.

16. The heat exchanger (20) according to any of the previous claims, wherein the wall thickness of the cooling flat tube (3) is 0.1-1.5 mm, preferably 0.8-1, 5 mm.

17. The heat exchanger (20) according to any of the previous claims, wherein the height of the cooling tube (3) is 1.2-15 mm.

18. The heat exchanger (20) according to any of the previous claims, wherein the frequency welded cooling flat tubes 83) have a braze cladding on at least one side.

19. The heat exchanger (20) according to any of the previous claims, wherein the fin insert has braze filler alloy cladding on at least one side (9, 10).

20. The heat exchanger (20) according to any of the previous claims, wherein the braze filler alloy has Mg content of 0.05-0.7 wt % Mg.

21. The heat exchanger (20) according to any of the claims 8-20, wherein thickness of material of the inserted fin insert (8) is 0.04-0.8 mm, preferably 0.5 to 0.7 mm.

22. A flat tube (3) for use in a compact heat exchanger (20) according to any of previous claims 1-21, characterized in that the tube (3) is bent from a sheet material (11) to form a sleeve, welded along the adjacent edges to form a tubular component and pressed to form a flat cooling tube (3).

23. The flat tube (20) according to claim 22, wherein the tube (3) has a weld joint (12) at the smaller dimension side (14, 14′).

24. The flat tube (3) according to claim 22, the flat tube (3) comprises a pre-fabricated fin inset (8) for facilitating the heat transfer efficiency

25. The flat tube (3) according to claim 24, characterized in that the tube (3) with the inserted fin insert (8) is calibrated by rolling between two rolls so that the fin insert (8) is fixed within the flat tube (3).

26. The fin insert (8) according to claim 8, wherein the insert (8) is formed by one of embossing, rolling, corrugating and stamping from a sheet material and then cut into the pieces of the appropriate dimension.

27. The fin insert (8) according to claim 8, wherein the insert (8) has fins with uneven shape along their length.

28. The fin insert (8) according to claim 8), wherein the insert (8) is manufactured from an aluminum alloy comprising Mn 0-3 wt %, Fe 0-1.5 wt %, Cu 0-1.5 wt %, Mg 0-1.5 wt % Si 0-1.0 wt %, Zn 0-4 wt %, Ni 0-1 wt % and Zr, Ti, Cr V 0-0.3 wt % each.

29. A method of manufacturing a heat exchanger (20) according to any of claims 1-22, comprising steps of:
bending a sheet material (11) to form a sleeve, welding the sleeve to form a tubular component, pressing the tubular component to obtain a flat tube (3);
manufacturing two manifolds with openings on their sides for receipt of ends (3a, 3b) of the tubes (3).
inserting tubes (3) into the openings so as to form the heat exchanger, characterized by assembling of the constituent parts by brazing.

30. The method of manufacturing the heat exchanger (20) according to claim 29, where the constituent parts are assembled by fluxless brazing.

31. The method of manufacturing the heat exchanger (20) according to claim 29 or 30, characterized by mounting at least one of the additional external fins (4, 7) and the stiffening plates (15).

32. A method of manufacturing a fin insert (8) according to claim 8, characterized by
one of direct chill casting, continuous casting, twin roll casting or belt casting from the aluminum alloy comprising Mn 0-3 wt %, Fe 0-1.5 wt %, Cu 0-1.5 wt %, Mg 0-1.5 wt % Si 0-1.0 wt %, Zn 0-4 wt %, Ni 0-1 wt % and Zr, Ti, Cr V 0-0.3 wt % each;
one of corrugating, stamping and embossing of the material so as to form a plurality of fins;
cutting the material having the plurality of the fins in the pieces of the appropriate size.

33. Use of the flat cooling tubes (3) according to claims 22-25 into the heat exchanger according to claims 1-21.

34. Use of the heat exchanger (20) of any of claims 1-21 for thermal management of any heat radiating component (5,6) in one of hybrid and electrical vehicle.
